(19) United States
(12) Patent Application Publication
(10) Pub. No.: US 2024/0010195 A1
(43) Pub. Date: Jan. 11, 2024

(54) METHOD FOR ASCERTAINING AN APPROXIMATE OBJECT POSITION OF A DYNAMIC OBJECT, COMPUTER PROGRAM, DEVICE, AND VEHICLE

(71) Applicant: Robert Bosch GmbH, Stutgart (DE)

(72) Inventors: Georg Rempfer, Leonberg (DE); Jonas Landsgesell, Mietingen (DE); Michael Tchorzewski, Boeblingen (DE)

(21) Appl. No.: 18/334,910

(22) Filed: Jun. 14, 2023

(30) Foreign Application Priority Data
Jun. 20, 2022 (DE) 10 2022 206 123.3

(51) Int. Cl. B60W 30/095; G06V 20/58

(52) U.S. Cl. CPC B60W 30/095; G06V 20/58; B60W 2554/4049; B60W 2420/54; B60W 2420/42

(57) ABSTRACT

A method for ascertainment of an approximate object position of a dynamic object in the surroundings of a vehicle. The method includes: detecting sensor data; ascertaining a present reflection origin position of a static or dynamic object as a function of the detected sensor data; detecting a camera image; recognition of the dynamic object as a function of the detected camera image; and ascertaining a present estimated position of the recognized dynamic object relative to the vehicle as a function of the detected camera image. When a position distance between the ascertained estimated position of the recognized dynamic object and the ascertained reflection origin position is less than or equal to a distance threshold value, a classification of the present reflection origin position as belonging to the recognized dynamic object takes place as a function of the underlying sensor data for the ascertainment of the reflection origin position.

### FIELD

The present invention relates to a method for ascertaining an approximate object position of a dynamic object in the surroundings of a vehicle that includes two ultrasonic sensors and at least one camera. Moreover, the present invention relates to a computer program, including commands which, when the program is executed by a computer, prompt the computer to carry out the steps of the method according to the present invention. Furthermore, the present invention relates to a device, in particular a central or zonal processing unit or a control unit for a vehicle, including a processing unit that is configured in such a way that it carries out the steps of the method according to the present invention. Moreover, the present invention relates to a vehicle that includes this device.

### BACKGROUND INFORMATION

A park pilot system for a vehicle typically includes multiple ultrasonic sensors, and an evaluation unit that detects and processes the data of the sensors and outputs warnings concerning possible obstacles. In addition, use of camera data or camera images is conventional in park pilot systems, as the result of which, for example, static and/or dynamic objects in the vehicle surroundings are recognized by trained machine recognition methods, based on image data, and further processed, for example, for emergency braking assistants and/or a visualization of the surroundings of the vehicle for the driver by generating a surround view or a top-down view with overlays or fade-ins of additional information. For these purposes, the detected camera images may be equalized, prepared, and transformed, for example, in particular with the aid of a central processing unit, with the aid of a zonal processing unit, or with the aid of a control unit.

The ultrasonic sensors of a park pilot system are generally situated in each case at the front and rear bumpers of a vehicle, over the entire vehicle width, for ascertaining data regarding the distance between the vehicle and objects in the surroundings of the vehicle. The ultrasonic sensors are typically configured to emit an ultrasonic signal. This emitted ultrasonic signal is reflected at obstacles. The reflected ultrasonic signal is once again received by the ultrasonic sensors as an echo signal, and from the propagation time a distance from the obstacle is computed. The ascertainment of the distance generally takes place as a function of a propagation time of a direct and/or indirect echo signal, or of a direct and/or indirect reflected ultrasonic signal or reflection signal for an emitted ultrasonic signal. The determination of the distance typically takes place with the aid of a sensor ASIC situated in a housing of the ultrasonic sensor. The sensor data of an ultrasonic sensor thus represent or include, for example, the reflected ultrasonic signal or the received echo signal and/or the computed distance as well as optional properties of the received echo signal, in particular relative to the emitted ultrasonic signal. A reflection origin position may typically be ascertained according to the trilateration principle as a function of at least one directly and one indirectly received echo signal and/or as a function of at least two directly received echo signals or at least two indirectly received echo signals. The trilateration principle presumes, for example, that the ultrasonic sensor neighboring an emitting ultrasonic sensor to the right and/or left is configured to receive a cross echo or the received echo signal or the indirect reflection signal for the emitted ultrasonic signal. The determination of the reflection origin position preferably takes place with the aid of a processing unit, for example with the aid of a microcontroller, that is situated in the control unit or in the zonal or central processing unit, for example, this processing unit, preferably a processor, advantageously detecting and processing sensor data of multiple, in particular neighboring, ultrasonic sensors.

German Patent Application No. DE 10 2010 045 657 A1 provides a surroundings monitoring system for a vehicle, the surroundings monitoring system including at least two distance sensors for distance recognition via propagation time measurement of detection signals.

German Patent Application No. DE 10 2019 205 565 A1 provides a method for assessing an object height based on received ultrasonic signals.

German Patent Application No. DE 10 2018 216 790 A1 provides a method for assessing an effect of an object in the surroundings of a means of transportation on a driving maneuver of the means of transportation.

It is conventional in the related art that the position of recognized objects, for example the position of a pedestrian, may be estimated based on at least one camera image, for example a base point determination of the object taking place. However, this position estimation for pedestrians does not function, for example, when the objects are in the immediate vicinity of a vehicle camera, since the objects can then no longer be completely captured in the camera image. In park pilot systems, multiple vehicle cameras including wide-angle lenses may be used, and a surround view or a top-down view for the driver may be displayed with the aid of a display device. In principle, these wide-angle cameras are better suited for recognizing nearby objects; however, the camera-based position estimation may fail for objects in the close range of the vehicle.

The Kalman filter is used for the iterative estimation of state parameters of a system based on erroneous measurements, the errors of the measurements being reduced. The use for evaluating radar signals or GNSS data for position determination of moving objects, is conventional. There is a problem of the association of measurements with a track of the moving object. This means that when incorrect measurements are associated with a track of the object, this results in a relatively large error in the determined position and further evaluations. For example, in a typical park pilot system it is often not possible to distinguish between pedestrians and neighboring curbs, as the result of which the position determination and movement estimation for a pedestrian become imprecise.

An object of the present invention is to improve an ascertainment of an object position of a dynamic object in the surroundings of a vehicle, in particular with regard to continuous tracking of a pedestrian as a dynamic object, or tracking of the pedestrian in the close range of the vehicle.

### SUMMARY

The above object is achieved according to features of the present invention.

The present invention relates to a method for ascertaining an approximately actual object position or approximate object position of a dynamic object in the surroundings of a vehicle. The vehicle includes at least two ultrasonic sensors and at least one vehicle camera. According to an example embodiment of the present invention, the method includes a detection of sensor data with the aid of the at least two ultrasonic sensors of the vehicle. The detection of the sensor data takes place in particular continuously. The sensor data represent in particular at least one detected echo signal for an emitted ultrasonic signal between the vehicle and an object in the surroundings of the vehicle, and preferably a distance between the vehicle and the object, and optionally at least one property of the received echo signal. The property of the detected echo signal is based in particular on an evaluation of the detected echo signal, and advantageously represents a likelihood of the presence of a dynamic object. The evaluation of the echo signal for determining a likelihood of the presence of a dynamic object is a preferred optional method step. A present reflection origin position of a static or dynamic object is subsequently ascertained at least as a function of the detected sensor data of the at least two ultrasonic sensors of the vehicle, in particular using a trilateration method. The ascertainment of the present reflection origin position takes place in particular continuously, based on the presently detected sensor data of the at least two ultrasonic sensors of the vehicle. At least one camera image is detected in a further method step with the aid of the vehicle camera; in particular, a continuous detection of a camera image takes place with the aid of the vehicle camera. Accordingly, a sequence of camera images is preferably detected with the aid of the vehicle camera. The dynamic object is subsequently recognized by at least one (first) trained machine recognition method as a function of the at least one detected camera image, the trained machine recognition method preferably being a trained neural network. For example, the recognized dynamic object is another moving or nonmoving vehicle, a standing or walking pedestrian, a cyclist, or an animal, for example a dog or a cat. An ascertainment of a present estimated position of the recognized object relative to the vehicle subsequently takes place as a function of the at least one detected camera image. It may be provided that this estimated position is additionally ascertained with the aid of a motion equation, for example when a pedestrian can no longer be recognized as a dynamic object in the present image, since the pedestrian at least partially obscures the image. Alternatively or additionally, the ascertained present estimated position may be determined by a base point ascertainment or by some other trained machine recognition method, in particular a trained neural network, and/or as a function of a motion estimation of the recognized object. The present estimated position changes in particular continuously over time, since the dynamic object is movable. The motion estimation of the recognized object may advantageously take place based on a change in a size of an object box for the recognized object and a base point determination of the recognized object in consecutively detected camera images. If it is recognized in a subsequent method step that a position distance between the present estimated position of the recognized dynamic object in the surroundings of the vehicle, in particular relative to the vehicle, and the present reflection origin position is less than or equal to a distance threshold value, the present reflection origin position is classified, as a function of the underlying sensor data for ascertaining the present reflection origin position and/or in particular as a function of the at least one property of the echo signal, as belonging to the recognized dynamic object, it being optionally possible for this property of the echo signal to be ascertained as a function of the sensor data or of the echo signal. The classification preferably takes place as a function of an amplitude of the underlying detected echo signal of the sensor data and/or as a function of a correlation coefficient between the detected echo signal and the emitted ultrasonic signal as the particular property of the detected echo signal of the detected sensor data. The sensor data may include or represent this property when a processing unit of the ultrasonic sensor has ascertained the property as a function of the echo signal and in particular of the emitted ultrasonic signal, and this at least one ascertained property is provided in the sensor data. Alternatively or additionally, at least one property of the echo signal may be ascertained in the method as a function of the detected sensor data. It is preferably recognized, based on at least two properties of the echo signal, with the aid of a second trained machine recognition method, in particular a second neural network, whether or not the reflection origin position may be classified as belonging to the dynamic object. The approximate object position of the dynamic object is subsequently ascertained as a function of the reflection origin position classified as belonging to the dynamic object, in particular using a Kalman filter. This ascertainment of the approximate object position of the dynamic object is carried out in particular continuously. The present invention results in the advantage that in the close range of the vehicle, an accurate approximate object position of the dynamic object, recognized based on camera images, may be determined as a function of ultrasonic measurements. The ultrasonic sensors provide very accurate measured values in the close range of the vehicle, and in particular the camera images in the close range of the vehicle are in part evaluable only with difficulty. In addition, the assignment or association of the determined reflection origin positions to/with the dynamic objects is improved, since measured values for static objects, for example curb edges, plantings, posts, or the like are not taken into account. It is particularly advantageous that even approximate object positions of pedestrians that are situated close to the vehicle, i.e., at a distance of less than or equal to 2 meters, for example, may be determined very accurately, which is relevant for parking operations in parking facilities, for example, since this pedestrian position can no longer be accurately estimated based on cameras due to the fact that the camera image cannot completely capture the pedestrians, in particular the legs and feet.

In one optional embodiment of the present invention, the classification of the present reflection origin position as belonging to the recognized dynamic object additionally takes place as a function of the underlying sensor data of the reflection origin positions, classified as belonging to the recognized dynamic object, during a predefined time period prior to the present point in time in the surroundings of the present reflection origin position, the predefined time period being in a range of 10 milliseconds and 3 seconds, for example. In other words, in the classification it is taken into account whether the underlying sensor data for the reflection origin positions, classified as belonging to the recognized dynamic object, in the surroundings of the present reflection origin position indicate a likelihood of the present reflection origin position belonging to the dynamic object. This classification may advantageously take place via a further trained machine recognition method. Alternatively or additionally, the present reflection origin position may be assigned in particular to the reflection origin positions previously classified as belonging to the recognized dynamic object, based on a similar property of the echo signal of the sensor data. Alternatively or additionally, the present reflection origin position may be classified or not classified as belonging to the recognized dynamic object in particular based on a plausibility of the temporally changed position of the reflection origin positions previously classified as belonging to the recognized dynamic object. Since the information of the ascertained reflection origin positions from the surroundings, classified as belonging to the dynamic object, is taken into account for the ascertained present reflection origin position, the advantage results that the present reflection origin position may be more accurately classified as belonging to the recognized dynamic object. In particular, present reflection origin positions ascertained in this embodiment may be classified in an enhanced manner as belonging to static objects or other dynamic objects, i.e., classified as not belonging to the recognized dynamic object. As a result of the embodiment, the association of the reflection origin position with the dynamic object thus takes place more reliably, as the result of which the ascertainment of the approximate object position of the dynamic object becomes more accurate.

In one refinement of the above-described optional embodiment of the present invention, the surroundings of the present reflection origin position include those reflection origin positions, assigned to the dynamic object or classified as belonging to the dynamic object, whose distance from the present reflection origin position is less than or equal to a distance threshold value. This distance threshold value is adapted in particular as a function of a speed of the vehicle. According to an example embodiment of the present invention, alternatively or additionally, the surroundings of the present reflection origin position include at least one ultrasonic cluster that is assigned to the dynamic object, the ultrasonic cluster in particular including reflection origin positions classified as belonging to the dynamic object and/or including an extension and/or having a predefined geometric shape. Alternatively or additionally, the surroundings of the present reflection origin position include at least one grid cell of a grid of the present reflection origin position, the grid subdividing the surroundings of the vehicle. By use of these types of surroundings descriptions of the present reflection origin position, the advantage results that reflection origin positions classified as belonging to the dynamic object are further filtered, so that, for example, various dynamic objects of the same class, for example different pedestrians, may be more easily separated from one another, as the result of which the ascertainment of the approximate object position of the individual dynamic object becomes more accurate.

In another optional refinement of the present invention, a present object speed of the dynamic object and/or of a present object movement direction of the dynamic object are/is ascertained as a function of the ascertained approximate object positions of the dynamic object at different points in time. In this refinement, the advantage results that the ascertainment of the object speed and/or of the object movement direction takes place accurately, since the approximate object positions are accurately ascertained.

In a further optional embodiment of the present invention, the ascertainment of the approximate object position of the dynamic object and/or the ascertainment of the present object speed and/or of the present object movement direction of the dynamic object in each case are/is not carried out if the number of reflection origin positions classified as belonging to the dynamic object falls below a predefined confidence number. In this optional embodiment, greater reliability of the ascertained approximate object position, of the ascertained object speed, and of the ascertained object movement direction is achieved.

In addition, according to an example embodiment of the present invention, it may be provided that a determination of a statistical uncertainty is carried out as a function of the detected sensor data and/or of the ascertained present reflection origin position and/or of the reflection origin positions classified as belonging to the dynamic object and/or of the ascertained approximate object position. The distance threshold value is subsequently adapted as a function of the determined statistical uncertainty. In this optional embodiment, the reliability and the accuracy of the ascertained approximate object position, of the ascertained object speed, and of the ascertained object movement direction are increased.

The distance threshold value is preferably in a range between meter and 5 meters, and in particular the distance threshold value is 0.5 meter, 1 meter, 1.5 meters, or 3 meters. This results in the advantage that reflection origin positions that represent a different dynamic object in the surroundings of the vehicle are not erroneously classified by the method or the algorithm as belonging to the recognized dynamic object, or multiple dynamic objects may be separated from one another.

The distance threshold value is optionally adapted as a function of the vehicle speed. This results in the advantage that an increasing inaccuracy in the ascertainment of the present estimated position of the recognized object is taken into account with increasing vehicle speed, so that a more reliable classification of the reflection origin positions as belonging to the recognized dynamic object takes place at higher vehicle speeds, so that the ascertainment of the approximate object position of the dynamic object takes place more exactly as a function of the reflection origin positions classified as belonging to the dynamic object.

In another optional embodiment of the present invention, a normalization of at least a portion of the underlying sensor data for ascertaining the present reflection origin position with regard to their amplitude may be carried out in an additional method step, based on an angular position of the ascertained present reflection origin position for the detection range of the ultrasonic sensor. In this embodiment, the classification of the present reflection origin position as belonging to the recognized dynamic object takes place as a function of the normalized underlying sensor data and as a function of an amplitude threshold value, those reflection origin positions having a normalized amplitude less than or equal to the amplitude threshold value preferably being classified as belonging to the recognized dynamic object. The particular present reflection origin position is reliably classified by use of this embodiment.

Optionally, it may be further provided that a correlation coefficient between at least a portion of the detected sensor data underlying the reflection origin position and the sensor signal emitted by the ultrasonic sensor is additionally ascertained. In this embodiment, the classification of the present reflection origin position as belonging to the recognized dynamic object takes place as a function of the ascertained correlation coefficient and as a function of a correlation threshold value, those reflection origin positions having a correlation coefficient less than or equal to the correlation threshold value preferably being classified as belonging to the recognized dynamic object. As a result of this embodiment, the particular present reflection origin position is classified more reliably as belonging to the dynamic object, in particular when the classification is additionally carried out as a function of the normalized underlying sensor data and as a function of an amplitude threshold value.

In another optional embodiment of the present invention, the number of reflections for a sensor signal that is emitted by the ultrasonic sensor is ascertained as a function of at least a portion of the detected sensor data underlying the present reflection origin position. The classification of the present reflection origin position as belonging to the recognized dynamic object is subsequently carried out as a function of the ascertained number of reflections and as a function of a number threshold value, those reflection origin positions whose number of reflections is less than or equal to the number threshold value being classified as belonging to the recognized dynamic object. As a result of this embodiment, the particular present reflection origin position is classified very reliably as belonging to the dynamic object, in particular when the classification is additionally carried out as a function of the normalized underlying sensor data and as a function of an amplitude threshold value, and/or in particular when the classification additionally takes place as a function of the ascertained correlation coefficient and as a function of a correlation threshold value.

In one optional embodiment of the present invention, it may preferably be provided that the classification of the present reflection origin position as belonging to the recognized dynamic object takes place via a second trained machine recognition method.

Moreover, the present invention relates to a computer program that includes commands which, when the program is executed by a computer, prompt the computer to carry out the steps of the method(s) of the present invention disclosed herein.

Furthermore, the present invention relates to a device or a central processing unit or a zonal processing unit or a control unit for a vehicle. The central processing unit, the zonal processing unit, or the control unit include at least one first signal input that is configured to provide at least one first signal that represents detected sensor data of at least one ultrasonic sensor of the vehicle. The device also includes a second signal input that is configured to provide a second signal that represents detected camera images of a vehicle camera. A processing unit of the device, in particular a processor, is configured in such a way that it carries out the steps of the method according to the present invention.

In addition, the device includes an optional signal output, the signal output being configured to generate a control signal for a display device, a braking device, a steering device, and/or a drive motor as a function of the method carried out by the processing unit.

Moreover, the present invention relates to a vehicle that includes the device according to the present invention or the central processing unit according to the present invention or the zonal processing unit according to the present invention or the control unit according to the present invention.

Further advantages result from the following description of exemplary embodiments, with reference to the figures.

### BRIEF DESCRIPTION OF THE DRAWINGS

FIG. 1 shows a vehicle and a dynamic object in the immediate surroundings of the vehicle.

FIG. 2 shows a process sequence as a block diagram, according to an example embodiment of the present invention.

FIG. 3 shows a statistical distribution of the amplitudes of echo signals.

FIG. 4 shows a statistical distribution of the correlation coefficients of echo signals.

FIG. 5A shows ascertained reflection origin positions in the surroundings of the vehicle, according to an example embodiment of the present invention.

FIG. 5B shows subsequent reflection origin positions in the surroundings of the vehicle, according to an example embodiment of the present invention.

### DETAILED DESCRIPTION OF EXAMPLE EMBODIMENTS

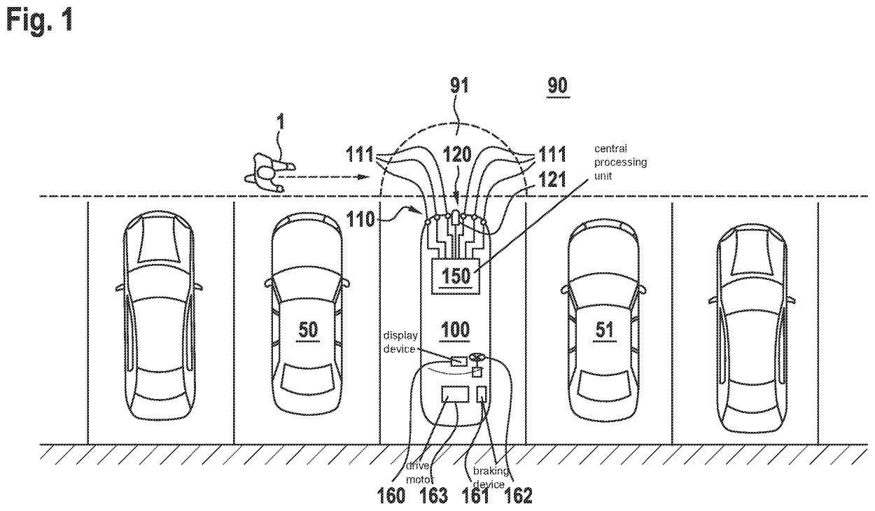

FIG. 1 schematically illustrates a vehicle 100 in a perpendicular parking space in a parking facility, and a dynamic object 1 in the immediate surroundings of vehicle 100, in a view from above. In this example, dynamic object 1 is a pedestrian. Vehicle 100 includes an ultrasonic sensor system 110 that includes four ultrasonic sensors 111 each at the front bumper and at the rear bumper. Vehicle 100 also includes a camera system 120 that includes at least rear vehicle camera 121, vehicle camera 121 preferably including a wide-angle lens. Vehicle camera 121 is configured to detect surroundings 90 of vehicle 100. The vehicle includes a central processing unit 150. Central processing unit 150 is electrically connected to the at least one vehicle camera 121 for the data transfer of camera images. It may advantageously be provided that camera system 120 includes at least four vehicle cameras 121, each of which is situated at a different side of the vehicle and which detects different areas of surroundings 90 from various perspectives, so that central processing unit 150 or a control unit may, for example, generate a view of the surroundings (surround view) based on the detected camera images of the four vehicle cameras. Central processing unit 150 is also electrically connected to the ultrasonic sensor system or to ultrasonic sensors 111 for the data transfer of sensor data of ultrasonic sensors 111. The sensor data received from particular ultrasonic sensor 111 with the aid of central processing unit 150 advantageously include or represent the particular detected echo signal for an emitted ultrasonic signal and/or the emitted ultrasonic signal, and/or distance data ascertained based on the echo signal with the aid of an ASIC in the particular ultrasonic sensor between vehicle 100 and an object 1 in surroundings 90 of vehicle 100, and optionally at least one property of the echo signal. The vehicle also includes a display device 160, a braking device 161, a steering device 162, and/or a drive motor 163, central control unit 150 being configured to activate display device 160, braking device 161, steering device 162, and/or drive motor 163 as a function of the received or detected sensor data and/or of the received or detected camera images. The pedestrian is detected in the detection range of vehicle camera 121 as a dynamic object 1. In the temporal observation, the dynamic object here moves past the adjacently parked first vehicle as a static object 50. It could be the intent of the pedestrian, as dynamic object 1, to pass vehicle 100 along planned movement direction 2, the pedestrian moving past static objects 50 and 51 or the adjacently parked first and second vehicles. In close range 91 of surroundings 90 of vehicle 100, the pedestrian, as dynamic object 1, will temporarily partially conceal, possibly temporarily completely conceal, a detection range of vehicle camera 121 during his/her movement. In addition, certain body parts of the pedestrian, as dynamic object 1 in close range 92 of vehicle 100, are temporarily not recognizable, for example the head or the feet. An accurate position determination of the pedestrian as dynamic object 1 based on a camera image of vehicle camera 121 is not possible then; for example, no base point ascertainment may be carried out in these cases. The ultrasonic sensors of ultrasonic system 110 detect static objects 50 and 51 or the adjacently parked vehicles as objects, and detect the pedestrian as dynamic object 1. This detection also takes place during the concealment of the detection range of the vehicle camera by the pedestrian or by dynamic object 1. In order to ascertain the object position, the object speed, and the object movement direction of the pedestrian as dynamic object 1 more accurately and also during the concealment of the detection range by the pedestrian, according to the present invention, the sensor data of dynamic object 1, based on the detection by the ultrasonic sensors, are classified or are separated from the sensor data of the ultrasonic sensors for static objects 50 and 51.

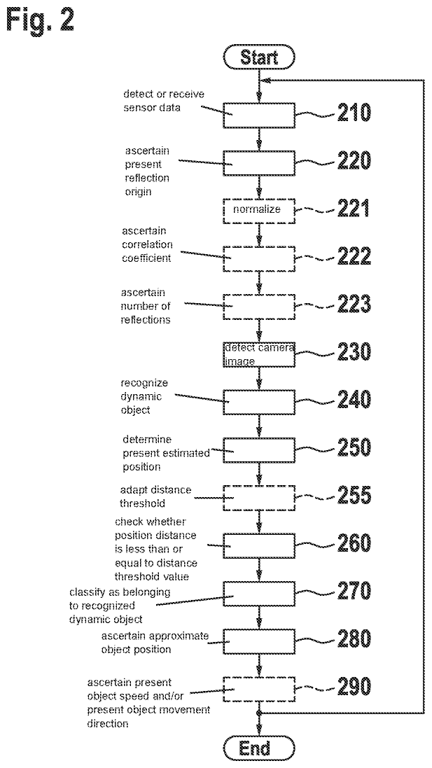

FIG. 2 schematically illustrates a process sequence as a block diagram. Sensor data are detected with the aid of the at least two ultrasonic sensors of the vehicle, or sensor data from the at least two ultrasonic sensors of the vehicle are received, in a method step 210. The sensor data in each case represent, for example, a distance between an object 1, 50, 51 that is present in surroundings 90 of vehicle 100 and vehicle 100, and advantageously represent a detected echo signal and in particular at least one property of the echo signal, for example a correlation coefficient between the detected echo signal and the emitted ultrasonic signal. A present reflection origin position of an object 1, 50, 51 relative to vehicle 100 is subsequently ascertained in step 220 as a function of the detected present sensor data. At least one camera image is detected with the aid of vehicle camera 121 in a further method step 230. In a subsequent optional step 221, it may be provided that at least a portion of the sensor data, including the detected echo signal, is normalized with regard to the amplitude, based on an angular position of the ascertained present reflection origin position for the detection range of the ultrasonic sensor. In a further optional step 222, a correlation coefficient is ascertained between at least a portion of the detected sensor data underlying the reflection origin position and the sensor signal emitted by the ultrasonic sensor, or is read out from the underlying sensor data if this correlation coefficient has already been ascertained in the ultrasonic ASIC or the ultrasonic sensor processing unit, and is contained or provided in the sensor data. Furthermore, in an optional step 223, the number of reflections for a sensor signal that is emitted by the ultrasonic sensor may be ascertained as a function of at least a portion of the detected sensor data underlying the present reflection origin position, or is read out from the underlying sensor data if this number of reflections for a sensor signal that is emitted by the ultrasonic sensor has already been ascertained in the ultrasonic ASIC or the ultrasonic sensor processing unit, and is contained or provided in the sensor data. The method also includes a detection 230 of at least one camera image with the aid of vehicle camera 121. A recognition 240 of dynamic object 1 is subsequently carried out as a function of the at least one detected camera image. The recognition of dynamic object 1 preferably takes place via a trained machine recognition method, in particular a neural network. It may be provided that the trained machine recognition method is configured to differentiate individual object classes of dynamic objects or to distinguish between subclasses of dynamic objects. A present estimated position of recognized dynamic object 1 relative to vehicle 100 is subsequently determined in step 250 as a function of the at least one detected camera image; in particular, the present estimated position is used as a base point ascertainment of recognized dynamic object 1. It may optionally also be provided that prior to a check 260, a distance threshold value is adapted in an optional step 255 as a function of a vehicle speed vehicle 100. It is checked in further method step 260 whether a position distance between the ascertained present estimated position of recognized dynamic object 1 and the ascertained present reflection origin position is less than or equal to the distance threshold value. The distance threshold value is preferably in a range between 0.1 meter and 5 meters, and in particular the distance threshold value is 0.5 meter, 1 meter, 1.5 meters, or 3 meters. If it has been recognized in method step 260 that the position distance between the ascertained present estimated position of recognized dynamic object 1 and the ascertained present reflection origin position is less than or equal to the distance threshold value, this presently ascertained reflection origin position is classified in step 270 as belonging to recognized dynamic object 1 as a function of the underlying sensor data for ascertaining the present reflection origin position and/or as a function of the optionally ascertained properties of the echo signal of the sensor data, in particular is classified as belonging to a recognized specific, individual object class or subclass of dynamic objects. Classification 270 of the present reflection origin position as belonging to the recognized dynamic object may optionally additionally be carried out as a function of the present reflection origin positions, already classified as belonging to the recognized dynamic object, during a predefined time period prior to the present point in time in the surroundings of the present reflection origin position, classification 270 then advantageously taking place as a function of the sensor data underlying these reflection origin positions and/or as a function of the optionally ascertained properties of the echo signal of the sensor data underlying these reflection origin positions. The predefined time period is in a range between 10 milliseconds and 3 seconds, for example. The surroundings of the present reflection origin position preferably include those reflection origin positions, assigned to the dynamic object, whose distance from the present reflection origin position is less than or equal to a distance threshold value. Alternatively or additionally, the surroundings of the present reflection origin position include at least one ultrasonic cluster assigned to the dynamic object. The ultrasonic cluster includes in particular reflection origin positions that are classified as belonging to the dynamic object. Alternatively or additionally, the surroundings of the present reflection origin position include at least one grid cell in which the present reflection origin position is situated or assigned, the grid of the grid cell subdividing surroundings of vehicle 100, in particular using a model, in particular into uniformly distributed rectangular or square grid cells or surroundings subareas. Classification 270 of the present reflection origin position as belonging to the recognized dynamic object preferably takes place as a function of the normalized underlying sensor data ascertained in step 221 and as a function of an amplitude threshold value, preferably those reflection origin positions having a normalized amplitude less than or equal to the amplitude threshold value being classified as belonging to the recognized dynamic object. Alternatively or additionally, classification 270 of the present reflection origin position as belonging to the recognized dynamic object takes place as a function of the correlation coefficient that is ascertained, or provided in the sensor data, and as a function of a correlation threshold value, preferably those reflection origin positions having a correlation coefficient less than or equal to the correlation threshold value being classified as belonging to the recognized dynamic object. Furthermore, it may alternatively or additionally be provided to carry out classification 270 of the present reflection origin position as belonging to the recognized dynamic object as a function of the ascertained number of reflections and as a function of a number threshold value, those reflection origin positions whose number of reflections is less than or equal to the number threshold value being classified as belonging to the recognized dynamic object. Classification 270 of the present reflection origin position as belonging to the recognized dynamic object is particularly preferably carried out by a second trained machine recognition method, in particular by a trained second neural network. The trained second neural network may determine or recognize a likelihood of the present reflection origin position belonging to the recognized dynamic object based, for example, on one or multiple properties of the echo signal, such as the at least one detected or normalized amplitude and/or the number of reflections contained in the echo signal and/or the correlation coefficient. After classification 270 of the present reflection origin position as belonging to the recognized dynamic object, an ascertainment 280 of the approximate object position of the dynamic object takes place as a function of the reflection origin positions classified as belonging to the dynamic object, in particular using a Kalman filter. It may subsequently be provided in optional step 290 to ascertain a present object speed and/or a present object movement direction of the dynamic object as a function of the ascertained approximate object positions of the dynamic object at different points in time. In one optional embodiment, ascertainment 280 of the approximate object position of the dynamic object and/or optional ascertainment 290 of the present object speed and/or of the present object movement direction of the dynamic object is not carried out if the number of reflection origin positions classified as belonging to the dynamic object falls below a predefined confidence number. In addition, a determination of a statistical uncertainty may be carried out in at least one further optional step as a function of the detected sensor data, of the ascertained present reflection origin position, of the reflection origin positions classified as belonging to the dynamic object, and/or of the ascertained approximate object position (not illustrated in FIG. 2). Alternatively or additionally, adaptation 255 of the distance threshold value subsequently takes place as a function of the determined statistical uncertainty. The method is preferably carried out continuously.

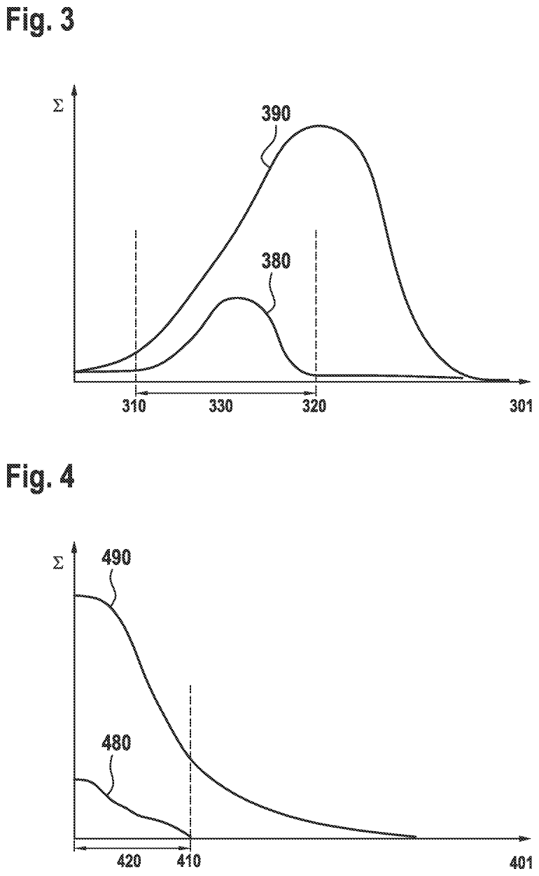

FIG. 3 schematically illustrates a statistical distribution of amplitudes 301 or the amplitude absolute values of echo signals that have been reflected at static objects 50 and 51 and dynamic objects 1. Graph 390 relates to the statistical distribution of amplitudes 301 or the amplitude absolute values of echo signals that have been reflected at static objects 50 and 51. Graph 380 relates to the statistical distribution of amplitudes 301 or the amplitude absolute values of echo signals that have been reflected at dynamic objects 1. It is apparent that a dynamic object 1 typically does not have an amplitude 301 that is smaller than a first amplitude threshold value 310 or greater than a second amplitude threshold value 320. Consequently, if the amplitude of the echo signal is less than first amplitude threshold value 310 or greater than second amplitude threshold value 320, it may be concluded with a high likelihood that a dynamic object is present. However, if the amplitude in range 330 is between amplitude threshold value 310 and second amplitude threshold value 320 or is greater than or equal to first amplitude threshold value 310 and less than or equal to second amplitude threshold value 320, a classification is not unambiguous, since amplitudes of echo signals that have reflected at static objects as well as amplitudes of echo signals that have reflected at dynamic objects are present in this range 330. Range 330 becomes considerably narrower, i.e., an exclusion of the reflection origin positions caused by static objects is improved, when the amplitude of the particular echo signal is additionally normalized in each case in the detection range of the particular ultrasonic sensor as a function of the angular position of the reflection origin position ascertained for same, since the amplitudes of the echo signals also vary relatively strongly as a function of this angular position. FIG. 4 schematically illustrates a statistical distribution of correlation coefficient 401 between the emitted ultrasonic signal of an ultrasonic sensor 111 and the received echo signal of ultrasonic sensor 111, the reflection of the emitted ultrasonic signal taking place at static and dynamic objects. Graph 490 relates to the statistical distribution of correlation coefficients 401 or the absolute values of correlation coefficients 401 of echo signals that have been reflected at static objects 50 and 51. Graph 480 relates to the statistical distribution of correlation coefficients 401 or the absolute values of correlation coefficients 401 of echo signals that have been reflected at dynamic objects 1. It is apparent that above a threshold value 410 for correlation coefficient 401, no correlation coefficients are present that may be associated with a dynamic object. In other words, the correlation coefficients for echo signals that have been reflected at dynamic objects are typically less than or equal to threshold value 410 for correlation coefficient 401. However, if the correlation coefficient is less than or equal to threshold value 410 for correlation coefficient 401, a classification as belonging to a dynamic object is not unambiguous, since in this range 420, correlation coefficients 401 of echo signals that have been reflected at static objects as well as correlation coefficients 401 of echo signals that have been reflected at dynamic objects are present.

Classification 270 of the particular reflection origin positions as a function of the properties of the underlying echo signals, shown in FIGS. 3 and 4, preferably takes place via a trained machine recognition method, in particular a trained neural network, for assessing the likelihood of the presence of a dynamic object, it being possible to take further properties of the underlying echo signals into account, for example the number of reflections determined in the echo signal. Due to the assessment of a plurality of properties of the echo signals by the trained machine recognition method, in particular the trained neural network, classification 270 of a present reflection origin position as belonging to a recognized dynamic object becomes very reliable.

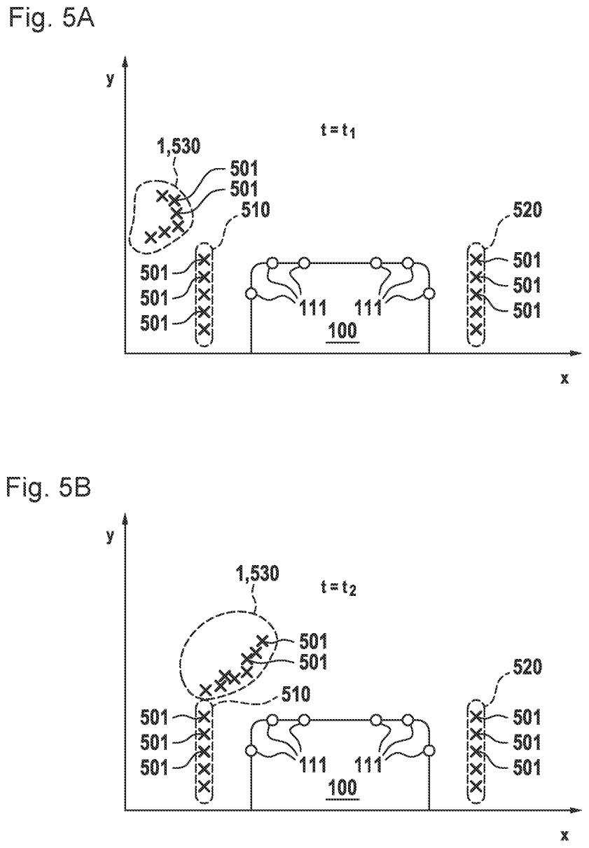

FIGS. 5A and 5B schematically illustrate ascertained reflection origin positions 501 in surroundings 90 of vehicle 100 in an x-y plane or in a map, in a perpendicular view from above at different points in time t1 and t2, reflection origin positions illustrated in FIGS. 5A and 5B resulting, for example, from a situation of a pedestrian, as a dynamic object, passing behind vehicle 100 according to FIG. 1. Point in time t2 is after point in time t1, for example, although in another situation the converse may be true, for example if the pedestrian moves behind the vehicle in the opposite direction. Ascertained reflection origin positions 501 thus represent static object 50 in area 510, and represent static object 51 in area 520 (the adjacently parked vehicles from FIG. 1), and represent the pedestrian as dynamic object 1 in area 530. Accordingly, classification 270 of particular present reflection origin positions 501 in method step 270 preferably also takes place as a function of reflection origin positions 501 in the surroundings of present reflection origin position 501.

FIG. 5B illustrates the situation from FIG. 5A at a later point in time. In this exemplary embodiment, area 510, which represents static object 50, directly adjoins area 530, which in this case represents the pedestrian as dynamic object 1. Areas 510, 520, and 530 may also overlap (not shown here), for example when a pedestrian as dynamic object 1 is walking past vehicle 100 on a sidewalk with a curb edge. It is apparent in FIG. 5B that the proximity of the reflection origin positions to one another in a map of the surroundings of vehicle 100 is not sufficient to allow a reliable classification 270 of the (present) reflection origin position to be carried out. Therefore, classification 270 takes place as a function of the sensor data underlying particular present reflection origin positions 501, which may include at least one property of the echo signal, and/or as a function of ascertained properties of the echo signal of these sensor data and/or as a function of reflection origin positions 501 in the surroundings of present reflection origin position 501, this classification 270 particularly preferably being carried out by a trained machine recognition method, as described above.

1-15. (canceled)

16. A method for ascertaining an approximate object position of a dynamic object in surroundings of a vehicle, the vehicle including at least two ultrasonic sensors and at least one vehicle camera, the method comprising the following steps:
detecting sensor data using the at least two ultrasonic sensors;
ascertaining a present reflection origin position of a static or dynamic object as a function of the detected sensor data;
detecting at least one camera image using the vehicle camera;
recognizing the dynamic object as a function of the at least one detected camera image; and
ascertaining a present estimated position of the recognized dynamic object relative to the vehicle as a function of the at least one detected camera image,
wherein when a position distance between the ascertained present estimated position of the recognized dynamic object and the ascertained present reflection origin position is less than or equal to a distance threshold value, the following steps are carried out:
classifying the present reflection origin position as belonging to the recognized dynamic object as a function of the sensor data for ascertaining the present reflection origin position, using a trained machine recognition method, and
ascertaining the approximate object position of the dynamic object as a function of the reflection origin positions classified as belonging to the dynamic object, using a Kalman filter.

17. The method as recited in claim 16, wherein the classification of the present reflection origin position as belonging to the recognized dynamic object additionally takes place as a function of the underlying sensor data of reflection origin positions, classified as belonging to the recognized dynamic object, during a predefined time period prior to the present point in time in surroundings of the present reflection origin position.

18. The method as recited in claim 17, wherein:
the surroundings of the present reflection origin position include those reflection origin positions belonging to the dynamic object whose distance from the present reflection origin position is less than or equal to a distance threshold value, and/or
the surroundings of the present reflection origin position include at least one ultrasonic cluster assigned to the dynamic object, the ultrasonic cluster including reflection origin positions classified as belonging to the dynamic object, and/or
the surroundings of the present reflection origin position include at least one grid cell in which the present reflection origin position is situated or assigned, a grid of the grid cell subdividing the surroundings of the vehicle.

19. The method as recited in claim 16, wherein the following step is additionally carried out:
ascertaining a present object speed of the dynamic and/or a present object movement direction of the dynamic object, as a function of ascertained approximate object positions of the dynamic object at different points in time.

20. The method as recited in claim 16, wherein: (i) the ascertainment of the approximate object position of the dynamic object and/or (ii) the ascertainment of the present object speed of the dynamic object and/or of the present object movement direction of the dynamic object, is not carried out in each case when a number of reflection origin positions classified as belonging to the dynamic object falls below a predefined confidence number.

21. The method as recited in claim 16, further comprising:
determining a statistical uncertainty as a function of the detected sensor data, and/or of the ascertained present reflection origin position, and/or of the reflection origin positions classified as belonging to the dynamic object, and/or of the ascertained approximate object position, and
adapting the distance threshold value as a function of the determined statistical uncertainty.

22. The method as recited in claim 16, wherein the distance threshold value is in a range between 0.1 meter and 5 meters.

23. The method as recited in claim 16, further comprising:
normalizing at least a portion of the sensor data for ascertaining the present reflection origin position with regard to their amplitude, based on an angular position of the ascertained present reflection origin position for a detection range of a particular one of the ultrasonic sensors,
wherein the classification of the present reflection origin position as belonging to the recognized dynamic object takes place as a function of the normalized sensor data and as a function of at least one amplitude threshold value.

24. The method as recited in claim 16, further comprising:
ascertaining a correlation coefficient between at least a portion of the detected sensor data underlying the reflection origin position and a sensor signal emitted by a particular one of the ultrasonic sensors;
wherein the classification of the present reflection origin position as belonging to the recognized dynamic object takes place as a function of the ascertained correlation coefficient and as a function of a threshold value for the correlation coefficient.

25. The method as recited in claim 16, further comprising:
ascertaining a number of reflections for a sensor signal emitted by a particular one of the ultrasonic sensors as a function of at least a portion of the detected sensor data underlying the present reflection origin position;
wherein the classification of the present reflection origin position as belonging to the recognized dynamic object taking place as a function of the ascertained number of reflections and as a function of a number threshold value.

26. The method as recited in claim 16, wherein the classification of the present reflection origin position as belonging to the recognized dynamic object takes place via a second trained machine recognition method.

27. A non-transitory computer-readable medium on which is stored a computer program that includes commands for ascertaining an approximate object position of a dynamic object in surroundings of a vehicle, the vehicle including at least two ultrasonic sensors and at least one vehicle camera, the commands, when executed by a computer, causing the computer to perform the following steps:
detecting sensor data using the at least two ultrasonic sensors;
ascertaining a present reflection origin position of a static or dynamic object as a function of the detected sensor data;
detecting at least one camera image using the vehicle camera;
recognizing the dynamic object as a function of the at least one detected camera image; and
ascertaining a present estimated position of the recognized dynamic object relative to the vehicle as a function of the at least one detected camera image,
wherein when a position distance between the ascertained present estimated position of the recognized dynamic object and the ascertained present reflection origin position is less than or equal to a distance threshold value, the following steps are carried out:
classifying the present reflection origin position as belonging to the recognized dynamic object as a function of the sensor data for ascertaining the present reflection origin position, using a trained machine recognition method, and
ascertaining the approximate object position of the dynamic object as a function of the reflection origin positions classified as belonging to the dynamic object, using a Kalman filter.

28. A device for a vehicle including a central processing unit or a zonal processing unit or a control unit, the device comprising:
a first signal input that is configured to provide at least one first signal that represents detected sensor data from an ultrasonic sensor of the vehicle;
a second signal input that is configured to provide a second signal that represents detected camera images of a vehicle camera;
a processor configured to for ascertaining an approximate object position of a dynamic object in surroundings of a vehicle, the processor configured to:
detect sensor data using the sensor;
ascertain a present reflection origin position of a static or dynamic object as a function of the detected sensor data;
detecting at least one camera image using the vehicle camera;
recognize the dynamic object as a function of the at least one detected camera image; and
ascertain a present estimated position of the recognized dynamic object relative to the vehicle as a function of the at least one detected camera image,
wherein when a position distance between the ascertained present estimated position of the recognized dynamic object and the ascertained present reflection origin position is less than or equal to a distance threshold value, the processor being configured to:
classify the present reflection origin position as belonging to the recognized dynamic object as a function of the sensor data for ascertaining the present reflection origin position, using a trained machine recognition method, and
ascertain the approximate object position of the dynamic object as a function of the reflection origin positions classified as belonging to the dynamic object, using a Kalman filter.

29. The device as recited in claim 28, further comprising:
a signal output, the signal output being configured to generate a control signal for a display device and/or a braking device and/or a steering device and/or a drive motor, as a function of the ascertained approximate object position of the dynamic object.

30. A vehicle, comprising:
a device for a vehicle including a central processing unit or a zonal processing unit or a control unit, the device including:
a first signal input that is configured to provide at least one first signal that represents detected sensor data from an ultrasonic sensor of the vehicle;
a second signal input that is configured to provide a second signal that represents detected camera images of a vehicle camera; and
a processor configured to for ascertaining an approximate object position of a dynamic object in surroundings of a vehicle, the processor configured to:
detect sensor data using the sensor;
ascertain a present reflection origin position of a static or dynamic object as a function of the detected sensor data;
detecting at least one camera image using the vehicle camera;
recognize the dynamic object as a function of the at least one detected camera image; and
ascertain a present estimated position of the recognized dynamic object relative to the vehicle as a function of the at least one detected camera image,
wherein when a position distance between the ascertained present estimated position of the recognized dynamic object and the ascertained present reflection origin position is less than or equal to a distance threshold value, the processor being configured to:
classify the present reflection origin position as belonging to the recognized dynamic object as a function of the sensor data for ascertaining the present reflection origin position, using a trained machine recognition method, and
ascertain the approximate object position of the dynamic object as a function of the reflection origin positions classified as belonging to the dynamic object, using a Kalman filter.
